(19) United States
(12) Patent Application Publication
(10) Pub. No.: US 2017/0107382 A1
(43) Pub. Date: Apr. 20, 2017

(54) ANTIOXIDANT CONDUCTIVE COPPER PASTE AND METHOD FOR PREPARING THE SAME

(71) Applicant: INSTITUTE OF NUCLEAR ENERGY RESEARCH, ATOMIC ENERGY COUNCIL, EXECUTIVE YUAN, R.O.C., Taoyuan City (TW)

(72) Inventors: WEI-CHEN CHANG, TAOYUAN CITY (TW); WEI-YANG MA, TAOYUAN CITY (TW); LI-WEI WENG, TAOYUAN CITY (TW); JUN-XIANG LIANG, TAOYUAN CITY (TW); CHENG-HUAN CHUNG, TAOYUAN CITY (TW); CHI-KAI CHUANG, TAOYUAN CITY (TW); TSUN-NENG YANG, TAOYUAN CITY (TW)

(21) Appl. No.: 14/953,159

(22) Filed: Nov. 27, 2015

(30) Foreign Application Priority Data
Oct. 20, 2015 (TW) 104134447

(51) Int. Cl. C09D 5/24; C09K 15/06

(52) U.S. Cl. CPC C09D 5/24; C09K 15/06

(57) ABSTRACT

An antioxidant conductive copper paste and a method for preparing the same are revealed. The antioxidant conductive copper paste includes conductive particles, a pasting agent, and a solvent. The conductive particles are copper nanoparticles or copper alloy nanoparticles. The pasting agent can be ethyl cellulose, Poly(3,4-ethylenedioxythiophene) (PEDOT), or epoxy. The solvent can be terpineol, ethylene glycol or diethylene glycol. The antioxidant conductive copper paste with features of high stability and low cost can be applied to produce electrodes of heterojunction solar cells.

### FIELD OF THE INVENTION

The present invention relates to a copper paste and a method for preparing the same, especially to a conductive copper paste and a method for preparing the same applied to electrode production of heterojunction solar cells and having features of low cost, good conductivity and antioxidant.

### BACKGROUND OF THE INVENTION

A solar cell is one of the most promising renewable energy sources available now. There are no greenhouse gases and polluting gases such as carbon dioxide, nitrogen oxides, sulfur oxides, etc. generated during operation of the solar cell. The solar cell converts the energy of light directly into electricity by the photovoltaic effect, without consuming non-renewable resources. Thus it has attracted a lot of attention lately when natural resources are gradually running out and energy cost is increasing.

The silver/silver composites paste is used in manufacturing of solar cell electrodes. The nano silver paste has high electrical conductivity. Yet silver is a precious metal so that the cost is higher. Moreover, silver nanoparticles are manufactured at higher temperature and the electrode made therefrom is easy to have migration of ions. Thus there is a need to develop nanoparticles of other metals for replacing the silver nanoparticles.

Copper nanoparticles with much lower cost are one of the choices with great potential as replacement for silver nanoparticles. There are many methods used for preparation of copper nanoparticles. In early days, hydrazines are used as a reducing agent for preparation. But toxicity and hazards of hydrazine are quite high. If sodium borohydride or sodium phosphanide is used as the reducing agent for preparation, impurities generated are difficult to be removed. Moreover, the preparation should be carried out under vacuum. Both increase the production cost. Some other methods for preparation have been developed. For example, copper hydroxide is used as the precursor salt and L-ascorbic acid is used as the reducing agent. The wet chemical method involves the reduction of the precursor salt, without using toxic materials. A polymer protector is used for preventing the product from oxidation. Moreover, a hydrothermal method is used to prepare copper nanoparticles coated by nano silver. The copper nanoparticles are used as cores and are coated with a layer of silver having a thickness ranging from 2-5 nanometers. Thus not only the amount of silver used is reduced, the antioxidant of the copper nanoparticles is also improved.

The most concern is easy oxidation of copper nanoparticles for replacement of silver nanoparticles used in conductive paste by copper nanoparticles. During preparation of copper nanoparticles used in the conductive copper paste by the ways mentioned above or other ways, a specific solvent is required for uniform dispersion of copper nanoparticles and prevent clustering of copper nanoparticles. The solvent also protects the copper nanoparticles from oxidization. Once the nano copper paste is oxidized, the electrodes of silicon solar cells and printed electronics produced by printing, coating or screen printing of the oxidized nano copper paste may have poor quality. Even the oxidization of the paste occurs after formation of the electrodes, the rapidly increasing resistance of the electrodes significantly reduces operation efficiency of the solar cells.

Refer to Taiwanese Pat. Pub. No. 201330305, a substrate with a passivation film, a method for preparing the substrate, a solar cell component and the method for preparing the same are revealed. The passivation layer of the solar cell is made from organoaluminium compounds while the counter electrode is made from copper paste available on the market. The composition of the copper paste is not revealed.

Refer to Chinese Pat. App. No. 201210260679.9, a conductive paste for a thick film circuit, a thick film circuit board employing the same and a manufacturing method thereof are revealed. Glass frit is used as an inorganic binder in the copper paste and the copper paste is applied to toughened glass substrates.

### SUMMARY

Therefore it is a primary object of the present Invention to provide an antioxidant conductive copper paste that includes copper nanoparticles with low cost and antioxidant. The copper nanoparticles are not easy to be oxidized due to specific components in conductive copper paste. Thus both the conductive copper paste itself and electrodes produced by various processes such as printing, coating, inkjet printing, etc thereof have pretty good stability. Their electrical resistance will not increase significantly over time.

It is another object of the present invention to provide an antioxidant conductive copper paste that is applied to various printed electronics such as printed circuit boards, Radio-frequency identification (RFID) smart tags.

It is a further object of the present invention to provide an antioxidant conductive copper paste whose viscosity is appropriate for screen printed wiring and able to maintain a certain thickness and form electrodes. Thus the sufficient thickness of the electrodes is ensured and a better electrical conductivity is provided.

It is a further object of the present invention to provide a method for preparing an antioxidant conductive copper paste, which includes a plurality of steps in specific order to get the conductive copper paste with specific components. Thus the antioxidant conductive copper paste obtained has good antioxidant and uniformly dispersed copper nanoparticles.

In order to achieve the above objects, an antioxidant conductive copper paste of the present invention includes 40%˜80% by weight of conductive particles; 1%˜10% by weight of a pasting agent; and 10%˜59% by weight of a solvent. The conductive particles can be copper nanoparticles or copper alloy nanoparticles. The pasting agent can be ethyl cellulose, Poly(3,4-ethylenedioxythiophene) (PEDOT), or epoxy. The solvent can be terpineol, ethylene glycol or diethylene glycol.

A method for preparing an antioxidant conductive copper paste according to the present invention includes a plurality of steps. Firstly mix conductive particles with anhydrous alcohol to form a conductive particle solution. Then mix a pasting agent and a solvent into the conductive particle solution in turn to get a mixed solution. The pasting agent is ethyl cellulose, poly(3,4-ethylenedioxythiophene) (PEDOT), or epoxy while the solvent is terpineol, ethylene glycol or diethylene glycol. Next use an ultrasonic homogenizer for homogenization of the mixed solution. Lastly remove all anhydrous alcohol in the mixed solution to get antioxidant conductive copper paste.

### BRIEF DESCRIPTION OF THE DRAWINGS

FIG. 1 shows a flow chart showing steps of a method of an embodiment according to the present invention.

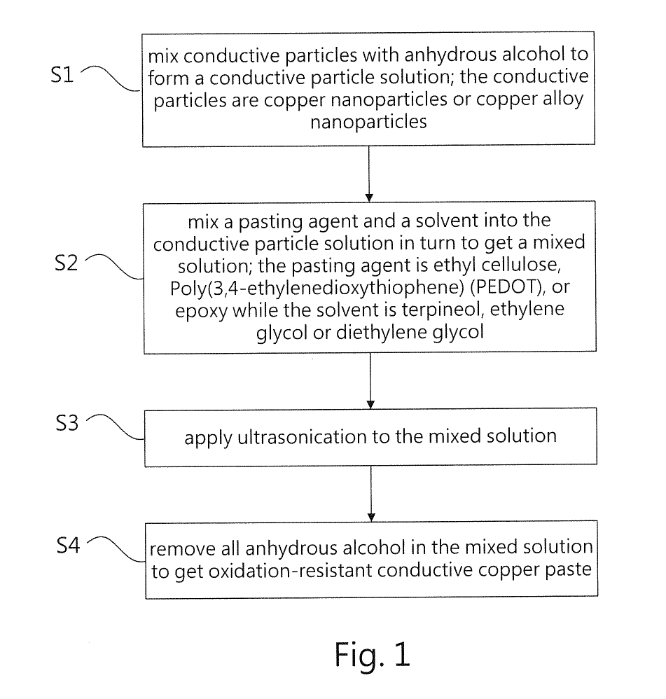

### DETAILED DESCRIPTION

In order to make the structure and characteristics as well as the effectiveness of the present invention to be further understood and recognized, the detailed description of the present invention is provided as follows along with embodiments and accompanying figures.

An antioxidant conductive copper paste of the present invention includes 40%˜80% by weight of conductive particles, 1%˜10% by weight of a pasting agent, and 10%˜59% by weight of a solvent.

The conductive particles are copper nanoparticles or copper alloy nanoparticles, whose cost is lower than silver nanoparticles. The conductive copper is used as the electrode material of the Heterojunction solar cell and is further applied to wiring of other printed electronics. The preparation method or resources of the copper/copper alloy nanoparticles are not limited. The copper nanoparticle or copper alloy nanoparticle has a particle diameter less than 1 micrometer (μm).

The conductive copper paste should have a certain viscosity for being applied to printing. Thus the present invention uses ethyl cellulose, poly(3,4-ethylenedioxythiophene) (PEDOT), or epoxy as the pasting agent. The electrical conductivity of the conductive paste comes from the copper/copper alloy nanoparticles. Thus the pasting agent is not limited to polymer with good electrical conductivity. For example, ethyl cellulose, or epoxy can be used instead of PEDOT with higher unit cost. Thus the antioxidant conductive copper paste of the present invention has the advantage of lower cost.

The solvent used in the present invention is terpineol, ethylene glycol or diethylene glycol. They are all non aqueous solvents for prevent copper/copper alloy nanoparticles from being oxidized into copper oxide after the nanoparticles being in contact with the solvent. Moreover, the terpineol, ethylene glycol or diethylene glycol also protects the copper/copper alloy nanoparticles from air. Thus the oxidation of the copper/copper alloy nanoparticles is further minimized.

While setting the mixture of the nanoparticles with the solvent on surface of the target object by printing, coating, inkjet printing, etc, the diffusion range of the mixture is difficult to control due to lower viscosity of the mixture. Thus the mixture is not suitable to be used as the carrier for conductive particles. The pasting agent in the present invention is used to improve the viscosity of the copper paste. In an embodiment of the present invention, the pasting agent is ethyl cellulose or epoxy while PEDOT is used as the pasting agent in another embodiment. The cost of ethyl cellulose/epoxy is much lower than that of PEDOT. Thus ethyl cellulose or epoxy is preferred to balance performance and cost. Ethyl cellulose is white or light gray flowing powder and is dissolved in anhydrous alcohol before being mixed with other components of the copper paste. Thus the addition of ethyl cellulose into the conductive copper paste will not result in rapid oxidation of the copper/copper alloy nanoparticles. The antioxidant of the mixture is still maintained.

A method for preparing an antioxidant conductive copper paste according to the present invention includes the following steps.
Step S1: mix conductive particles with anhydrous alcohol to form a conductive particle solution; the conductive particles are copper nanoparticles or copper alloy nanoparticles;
Step S2: mix a pasting agent and a solvent into the conductive particle solution in turn to get a mixed solution; the pasting agent is ethyl cellulose, Poly(3,4-ethylenedioxythiophene) (PEDOT), or epoxy while the solvent is terpineol, ethylene glycol or diethylene glycol;
Step S3: apply ultrasonication to the mixed solution; and
Step S4: remove all anhydrous alcohol in the mixed solution to get antioxidant conductive copper paste.

In the above steps, the materials being mixed include the conductive particles, the pasting agent and the solvent. The conductive particles are copper nanoparticles or copper alloy nanoparticles. The pasting agent can be ethyl cellulose, Poly(3,4-ethylenedioxythiophene) (PEDOT), or epoxy. The solvent can be terpineol, ethylene glycol or diethylene glycol.

In practice, disperse 6 g copper nanoparticles in 60 mL anhydrous alcohol to form a conductive particle solution. Then prepare a pasting agent going to be mixed into the conductive particle solution. Dissolve 0.35 g ethyl cellulose with a viscosity ranging from 5˜15 mPa s (milliPascal seconds) or 30˜60 mPa s in 14 g anhydrous alcohol. The mixture is mixed until clear with a magnetic stirrer and is heated to 80° C. for dissolution of ethyl cellulose and formation of the pasting agent. The conductive particle solution and the pasting agent can be prepared respectively at the same time for shortening time required for the manufacturing process. Moreover, the conductive particle solution and the pasting agent can be treated by ultrasonication of an ultrasonic homogenizer for dispersion and homogenization of various components before being mixed to each other. The ultrasonic homogenizer is operated at the mode of 2 seconds on and 3 seconds off. The mode is repeated for 2 minutes.

After the conductive particle solution and the pasting agent being mixed to each other, the mixture is treated by ultrasonication again. Then the solvent, terpineol, is added into the mixture. Next ultrasonication is carried out once again. The operation mode and duration of the ultrasonication are the same as mentioned above.

After homogeneous mixing of the conductive particle solution, the pasting agent and the solvent, a rotary evaporator is used for removal of all anhydrous alcohol by evaporation. Thus the product of antioxidant conductive copper paste contains no anhydrous alcohol. In this step, the anhydrous alcohol is removed in a 40 degrees Celsius (40° C.) environment. The pressure in the rotary evaporator is slowly decreased from 110 hPa to 80 hPa while the temperature is maintained at 40 degrees Celsius during the evaporation. After removal of anhydrous alcohol, one more step is taken. A roller is used to grind the antioxidant conductive copper paste for removal of bubbles in the copper paste. At the same time, the copper nanoparticles or copper alloy nanoparticles in the conductive copper paste can be dispersed more uniformly. The roller for grinding can be replaced by a three-roller machine.

In summary, the antioxidant conductive copper paste of the present invention features on low cost because no silver nanoparticles are used. Moreover, no water is involved during preparation process and contained in the final product to protect copper nanoparticles from oxidation. The antioxidant conductive copper paste is of practical and economic value due to low cost and superior performance.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An antioxidant conductive copper paste comprising:
40%˜80% by weight of conductive particles;
1%˜10% by weight of a pasting agent; and
10%˜59% by weight of a solvent;
wherein the conductive particles are selected from the group consisting of copper nanoparticles and copper alloy nanoparticles; wherein the pasting agent is selected from the group consisting of ethyl cellulose, Poly(3,4-ethylenedioxythiophene) (PEDOT), and epoxy; wherein the solvent is selected from the group consisting of terpineol, ethylene glycol and diethylene glycol.

2. The antioxidant conductive copper paste as claimed in claim 1, wherein the antioxidant conductive copper paste is used to form electrodes of heterojunction solar cells by printing.

3. The antioxidant conductive copper paste as claimed in claim 1, wherein the copper nanoparticles or the copper alloy nanoparticles has a particle diameter less than 1 micrometer (μm).

4. A method for preparing an antioxidant conductive copper paste comprising the steps of:
mixing conductive particles with anhydrous alcohol to form a conductive particle solution; wherein the conductive particles are copper nanoparticles or copper alloy nanoparticles;
mixing a pasting agent and a solvent into the conductive particle solution in turn to get a mixed solution; wherein the pasting agent is selected from the group consisting of ethyl cellulose, Poly(3,4-ethylenedioxythiophene) (PEDOT), and epoxy while the solvent is selected from the group consisting of terpineol, ethylene glycol and diethylene glycol;
applying ultrasonication to the mixed solution; and
removing all anhydrous alcohol in the mixed solution to get the antioxidant conductive copper paste.

5. The method as claimed in claim 4, wherein the method further includes a step of applying ultrasonication to the conductive particle solution after the step of mixing conductive particles with anhydrous alcohol to form a conductive particle solution.

6. The method as claimed in claim 4, wherein the anhydrous alcohol is removed in a 40 degrees Celsius (40° C.) environment in the step of removing all anhydrous alcohol in the mixed solution.

7. The method as claimed in claim 6, wherein a rotary evaporator is used for removing all anhydrous alcohol.

8. The method as claimed in claim 4, wherein the antioxidant conductive copper paste is printed on surface of a silicon substrate of a heterojunction solar cell and used as electrodes.

9. The method as claimed in claim 4, wherein the method further includes a step of using a roller to grind the antioxidant conductive copper paste after the step of removing all anhydrous alcohol in the mixed solution.
